(19) United States
(12) Patent Application Publication
(10) Pub. No.: US 2002/0188619 A1
(43) Pub. Date: Dec. 12, 2002

(54) System and method for generating dynamically updated graphical user interfaces

(76) Inventor: Michael Low, West Los Angeles, CA (US)

Correspondence Address: Bryan Cave LLP, 245 Park Avenue, New York, NY, 10167, US

(21) Appl. No.: 09/851,814

(22) Filed: May 9, 2001

(51) Int. Cl. G06F 7/00

(52) U.S. Cl. 707/104.1

(57) ABSTRACT

A system and method for generating dynamically updated graphical user interfaces over a distributed computer network is disclosed. The system and method use existing hypertext transfer protocols and existing Java Script and Active Server Pages to generate a dynamic graphical user interface based on a database of records identifying goods or services. The consumer is provided a range of predetermined choices and in accordance with replies to the predetermined choices, the graphical user interface is dynamically updated with icons and other graphic symbols representing the consumer choices. Importantly, the graphical user interface does not need to refresh the browser application and therefore, minimizes data transmission delays over the distributed computer network.

### FIELD OF THE INVENTION

The present invention relates generally to the field of distributed computer networks, and more particularly, to a system and method for generating dynamically updated graphical user interfaces for goods and services for sale.

### BACKGROUND OF THE INVENTION

The invention is primarily intended for use by merchants that require an easy way to define and utilize a catalog for displaying goods or services for sale via a distributed computer network such as the Internet. Accordingly, in the following description and appended claims, the term “merchant” will be used to mean an entity that will present products or services for sale to the general public and to other targeted audiences. A merchant typically displays a catalog of products or services for sale to be transmitted over the Internet to consumers. Accordingly, in the following description and appended claims, the term “consumer” will be used to mean an entity that will access such a catalog for browsing or purchase of products or services. However, it should be noted that the concepts of the invention are not limited merely to a traditional merchant and consumer relationship, but can be used for generating catalogs of any items, including purely informational catalogs to attract future sales.

As the Internet and similar distributed computer networks continue to grow, many web sites are becoming connected and more corporations are trying to do business on the web. Although most information is still given freely on the Internet, an increasing number of organizations are attempting to sell their products or services electronically. The area of electronic sales, or electronic commerce, has been developing rapidly. Electronic commerce promises to allow everyone, almost anywhere on the globe to which a web connection is available, to access any commercial business offerings catalog implemented as a web site. Moreover, the consumer would be able to access the catalog at anytime, 24 hours a day, seven days a week, and pay for these purchases.

In order to access the advantages of electronic commerce, merchants must have a systematic method of presenting the items and services for sale to the consumer. Merchants have long sought ways to present items to consumers for easier selection and purchase. Ideally, merchants would like to be able to present the whole collection of products and services offered for sale to consumers in an organized and informative way. One way to present the collection of items for sale is to present search engines on web sites to access a database of records identified with items and services for sale. However, in some cases, this approach may not be ideal since the consumer may not realize that the targeted product or service is in the database. Another drawback to a simple search engine on the web site is that simple queries may result in a voluminous amount of information which can sometimes result in the consumer being overwhelmed with choices.

Another way to present the items in a database for sale is to catalog the items in alphabetical or numerical order. However, organization of items in this manner can make exact items hard for consumers to reach. Yet another method of presenting the items in a database for sale is to provide an interactive question and answer format for consumers. This is typically accomplished by asking consumers to answer various questions and according to the consumer's answers, utilizing the consumer's replies to the questions to pinpoint the product or service that the consumer may require. However, the browser software application may then be required to make hypertext transfer requests after each question to sometimes distant web servers. The hypertext requests are sometimes accompanied by requests to be transmitted to a database of products and services which can slow down the transmission of data. Another drawback is that the static nature of the question and answer process implemented as a proxy for a search engine of the database does not function efficiently when the products or services have a myriad of interlocking options. This approach can result in consumers being reliant on the speed of their internet connection as the search engine constantly accesses the database (typically at the web server) and new questions are presented to the consumer.

Therefore, there is a need for a method of presenting items stored in a database so that the consumers can more easily find exactly the items that are required for their purposes.

### SUMMARY OF THE INVENTION

In accordance with the invention, a system and method for generating a dynamically updated graphical user interface is disclosed. In one aspect, this invention concerns a method of representing a search of a database over an interconnected data network between a merchant and a consumer, said consumer equipped with a browser application, said method comprising the steps of:

providing to consumers a set of predetermined choices;

receiving consumer replies to said set of predetermined choices;

dynamically providing graphic representations of icons reflecting said consumer replies; and

presenting selected consumer choices as a graphic image on said graphic user interface,

wherein said presenting step is accomplished without refreshing said browser application.

In another aspect, this invention concerns a system for dynamically representing a search of a database over an interconnected data network between a merchant and a consumer, said consumer equipped with a browser application, said system comprising:

means for providing to consumers a set of predetermined choices;

means for receiving consumer replies to said set of predetermined choices;

means for dynamically providing a graphical user interface reflecting said consumer replies without refreshing said browser application; and

means for presenting selected consumer choices as a graphic image on said graphic user interface.

### BRIEF DESCRIPTION OF THE FIGURES

A more complete understanding of the present invention may be obtained by considering the following description in conjunction with the drawings in which:

FIG. 1 is a schematic diagram of a conventional Internet interconnection between a consumer and a merchant;

FIG. 2 is a graphical user interface for selecting custom cable characteristics;

FIG. 3 is a graphical user interface for selecting custom wiring characteristics; and

FIG. 4 is a confirmation screen.

### DETAILED DESCRIPTION OF THE INVENTION

The Internet comprises a vast number of computers and computer networks that are interconnected through communication links. The interconnected computers exchange information using various services such as electronic mail, file transfer protocol, Gopher, and the World Wide Web (“WWW”). WWW service allows a server computer system to transmit web pages of textual and graphical information to a remote client computer system. The remote client computer system can then display the web pages. Each resource (e.g., computer or web page) of the WWW is uniquely identifiable by a Uniform Resource Locator (“URL”). To view the specific web page, a client computer system specifies a URL for a web page in a request (e.g., a hypertext transfer protocol request). The request is forwarded to the web server that supports that web page. When that web server receives the request, the server transmits that web page to the client computer system. When the client computer system receives that web page, it typically displays that web page using a browser. A browser is a special purpose application program resident on the client computer system that effects the requesting of web pages and the displaying of web pages.

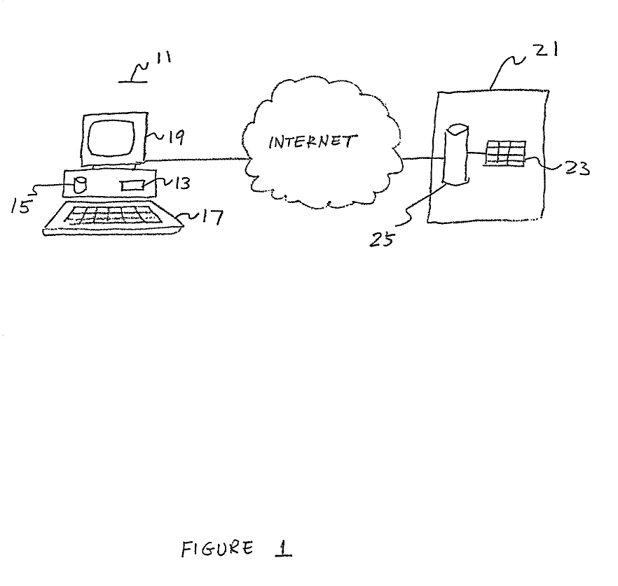

Referring to FIG. 1, the principal components of an Internet connection between a merchant and a consumer are illustrated. A personal computer 11 is employed to access an online catalog of products and services by a consumer. The personal computer 11 is generally conventional in design, comprising a central processor unit 13 and storage device 15 and supporting integrated circuitry. Coupled to the personal computer 11 is a keyboard 17 and monitor 19. Generally a browser (not shown) is resident on the personal computer for retrieving web pages. The personal computer is controlled by the consumer (not shown) using a keyboard and a mouse or other pointing device. It should be noted that although a personal computer is illustrated, it will be understood that a terminal, a personal digital assistant, a cellular telephone, or other type of portable computer can similarly be used in conjunction with the present invention for graphical user interface for merchants.

A web server 21 is employed to display a catalog of products or services offered for sale at a merchant's direction and is interconnected to the Internet. The merchant typically encodes a catalog of products or services for transmission from the web server in response to web page requests from web browsers resident at the consumer. The web server 21 is typically comprised of a central processing unit 23 and a storage device 25 and is capable of delivering web pages to users in response to a hypertext request transmitted from web browsers resident at the consumer. The storage device 25 generally includes a database of products or services arranged in a tabular form.

Computers on the Internet can communicate to each other with the high-level Hypertext Transfer Protocol (“HTTP”). HTTP is a generic stateless protocol for transporting information over the Internet. Among the traffic carried by the HTTP protocol are web pages. Currently, web pages are typically defined using hypertext markup language (“HTML”). HTML provides a standard set of tags that define how a web page is to be displayed. When a user indicates that he wants to be routed to a web page, the browser application software transmits a HTTP “GET” request to a domain name server (“DNS”), which performs a standard lookup of a corresponding internet protocol (“IP”) address. The web page request is then transmitted along with the translated IP address to the web server 21. The web server 21 typically responds to the “GET” request by transmitting a response code to indicate successful reception of the “GET” request.

The web server 21 returns to the client a web page encoded in HTML code. HTML is a scripting language which can arrange textual and graphic elements on a web page. HTML can include the placement of icons and other graphics in a manner approximating a printed page. These icons may be relocated or selected, which instructs the underlying operating system to relocate the referenced file in the directory structure, execute or open the file, depending on its type, or to operate on one referenced file by another referenced application. A known paradigm is “drag and drop”, which allows the one or more objects, represented by one or more icons, to be operated on by another object, also represented by a graphic object or icon. Such functions include, but are not limited to, move, copy, execute, filter, open, print, and delete.

The principles of the present invention will be further illustrated with a merchant that sells customized cable configurations to consumers. However, it will be understood that the general applicability of the present invention will be apparent for a variety of other products or services for sale over a distributed computer network.

Cable connectors provide an ideal example for this type of application because cables can be customized in many ways by the consumer. For instance, with cable connectors, the consumers do not know a lot of times what is required for the proper connection of peripherals to computers and peripherals to each other. Utilizing a known search engine would not be ideal because the consumer may not be aware of exactly the types of cables that are required for the consumer's situation. For instance, even with a standard personal computer configuration, most consumers may not be aware of whether the specific cable interface (typically located at the back of the personal computer) is a serial interface, a parallel interface, a universal serial bus (“USB”) interface, etc. Oftentimes, consumers need graphical and textual aids in identifying the proper cable interface. Therefore, there is a need for presenting items in a database in a manner that is more efficient and compact for a consumer.

Consumers can also be confused with the myriad type of choices for cables. Some attributes include the custom wiring patterns, jumpers and pair integrity of the cables. Some other attributes that the consumer may be able to choose between include the cable connector type, cable pin connections, and cable length. To date, there has been no systematic method of supplying consumers with the desired cable types without relying on human interaction at the time of ordering of the cables. When a consumer is looking for a specific type of cable, the consumer is often lost as to what type of cable is needed for a particular application. Consumers can be directed to the right type of cable by answering questions which may lead to the proper type and length of cable required. The recommended items are then displayed to the consumers. In prior art solutions, the customizable attributes had to be hand notated or jotted down on a purchase order form and relied on human judgment and transcription skills. The present invention eliminates the errors that can result from human transcription error while allowing the consumer to have full flexibility in ordering the desired cables.

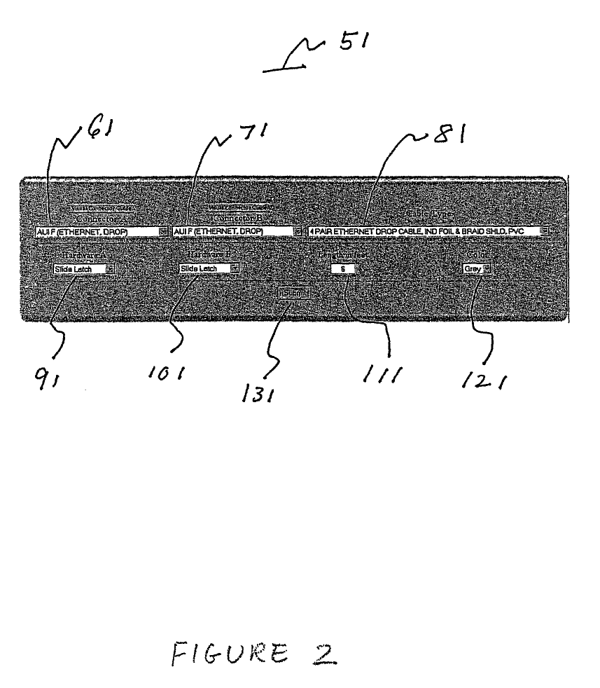

The customer is first directed to an initial choice graphic user interface for selecting custom cable characteristics. Referring to FIG. 2, there is shown a graphical interface 51 in accordance with the principles of the present invention. The graphical interface serves as a front-end for the consumer at the client computer and serves to access the database at the server computer. In one embodiment, the graphical interface is implemented as a Java Script applet. Java Script programs, or applets, can be embedded into web pages and used on computers running any operating system. Basically, Java is a programming language, and programmers write source code and translated into bytecode, a special streamlined format which can be applicable to any programming platform. In one embodiment, the access to the database at the server computer is performed by a server-side active server pages (“ASP”). It is contemplated that all of the data for this screen is stored in the database of cables so that it can be added to or changed as easily as changing one row in the table.

The consumer is firnished selectable cable attributes in the form of drop down boxes. The selectable attributes for the custom cables include (1) Connector A 61, (2) Connector B 71, (3) Cable Type 81, (4) Hardware A 91, (5) Hardware B 101, (6) Length 111, and (7) Color 121. The particular graphical user interface is used for selecting cable types and cable lengths. The consumer may select from the following cable attributes arranged in drop down boxes shown as a web page. Each drop down box corresponds to a selectable cable attribute. Each drop down choice is discussed in turn herein:

(1) Connector A: Connector A is one end of the connector of cable type. The choices in the drop down box are dynamically generated lists of possible connectors. The list is generated from the database of connector types. Importantly, the selected value of Connector A automatically limits the choices of four other lists (which are discussed herein): Cable Type, Hardware A, Connector B, Hardware B. Server-side active server pages (“ASP”) draw from the database when the page loads. The data for all of the changing lists is downloaded to the consumer when the page is first loaded. The data for all of the changing lists are downloaded to the consumer's computer 11 and stored as cookies, or small text files stored on the hard disk 15, when the page is first loaded. Client-side Java Script changes one list depending on the value selected in another list so that the consumer receives instant results without waiting for the page to reload. The interlocking characteristics of the cable are reflected within the graphic user interface without a possibly lengthy data transfer from the web server 21.

(2) Connector B: A list of possible Connectors. Only connectors that work with connector A are shown. It should be noted that changing the connector B automatically changes the hardware B list. Again, this is accomplished using client-side Java script.

(3) Cable Type: A list of possible cable types that work with Connector A and Connector B

(4) Hardware A: The list of possible hardware to physically attach connector A to fasten it to a computer or device (e.g., side latch, thumb screws, etc.).

(5) Hardware B: The list of possible hardware to physically attach connector B to fasten it to a computer or device.

(6) Length: A textbox where the consumer enters the desired cable length.

(7) Color: A list of colors available for that cable.

After choosing the appropriate characteristics, when the consumer subsequently presses the submit button 131, the consumer is directed to go to one of the two screens depending on the selections made at the initial screen. If the consumer chooses a cable that only has one or two wires and thus does not allow custom wiring the consumer is directed to a confirmation screen to confirm the cable characteristics. Otherwise, the consumer is directed to screen 2 to construct a custom wiring diagram where the consumer can specify pin connections from pins in Connector A with pins in Connector B.

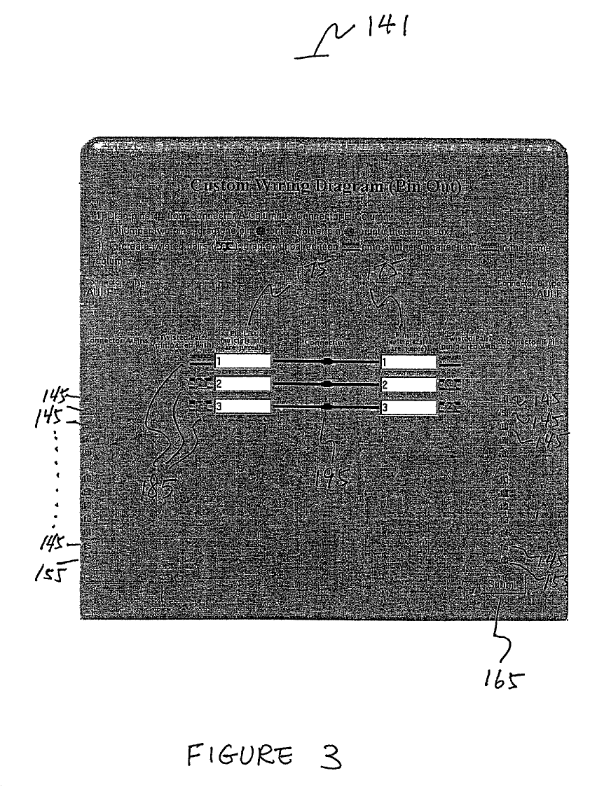

Referring to FIG. 3, there is shown the second screen of the graphical user interface in accordance with the principles of the present invention. The graphic user interface 141 is for selecting the custom wiring characteristics of the custom cable. A small circular icon 145 each represents a pin on both connector A and connector B. It will be noted that the number of pins 145 for each connector reflects the choice of cable type presented in the initial screen of FIG. 2. A “C” icon 145 is additionally presented to the consumer for connecting a wire to connector A or Connector B itself. The screen is divided into two sides, the Connector A side and the connector B side.

The consumer may “drag and drop” a single pin icon 145 from one side to a single pin 145 on the other side to reflect an electrical connection. If the consumer attempts to drag a pin over an invalid target, then the pin 145 is returned to the original location. A pin icon 145 from one connector can be dragged and dropped onto various targets within the graphic user interface 141. A pin icon 145 from one connector can be dragged to a corresponding pin icon 145 for the other connector. This specifies an electrical connection between the pins 145 of the connectors. The electrical connection is instantly reflected in the wiring schematic text boxes 175 to reflect the connection from connector A to connector B. The corresponding connector A pin number appears in the text box 175 on the connector A side and the Connector B pin number appears in the text box on the Connector B side.

In an alternate embodiment, the consumer may specify the pin connections by specifying the electrical connections with appropriate pin numbers entered directly onto the text boxes 175. Consumers may be instructed to enter the pin numbers, separated by commas to signify an electrical connection. Any number of pins may be electrically connected in this way.

The consumer may drag and drop a pin icon 145 from one connector to another pin icon 145 on the same connector. This will signify two pins being jumpered on the same connector.

Certain cable types have twisted pairs (for e.g., high resolution video cables have 3 coaxial cables and 5 twisted pair cables). An unpaired icon 185 is employed to facilitate a twisted pair connection. If the cable type selected on screen 1 has twisted pairs, then each text box in the diagram is accompanied by an unpaired icon 185. Dragging the unpaired icon 185 from one pin to the unpaired icon 185 for another pin on the same connector signifies that the two wires are paired. For example, referring back to FIG. 3, on the Connector A side, the unpaired icon 185 for pin 2 was dragged and dropped on the unpaired icon 185 for pin 3. The unpaired icon 185 for pin 3 was marked with a 2, and the unpaired icon 185 for pin 2 was marked with a 3. Therefore, one skilled in the art can see that the pins 2 and 3 are a twisted pair and can be coupled to a corresponding twisted pair on connector B.

The consumer is additionally allowed to click on the illustrated connection by placing a dot 194 in the middle of a connection to cause the electrical connection to be deleted. If the consumer hovers over the dot 194, with the pointing device, the column heading giving the consumer the choice to abandon the connection altogether. The connection line and the attached text boxes are subsequently available to be reassigned.

Similarly, the assignment of a twisted pair icon to a pair of pins can be canceled. If the consumer clicks on either twisted pair icon (for e.g., pins 2 and 3 in the example illustrated in FIG. 3), the wires will be untwisted as to the corresponding pins. The corresponding pins are subsequently available to be reassigned.

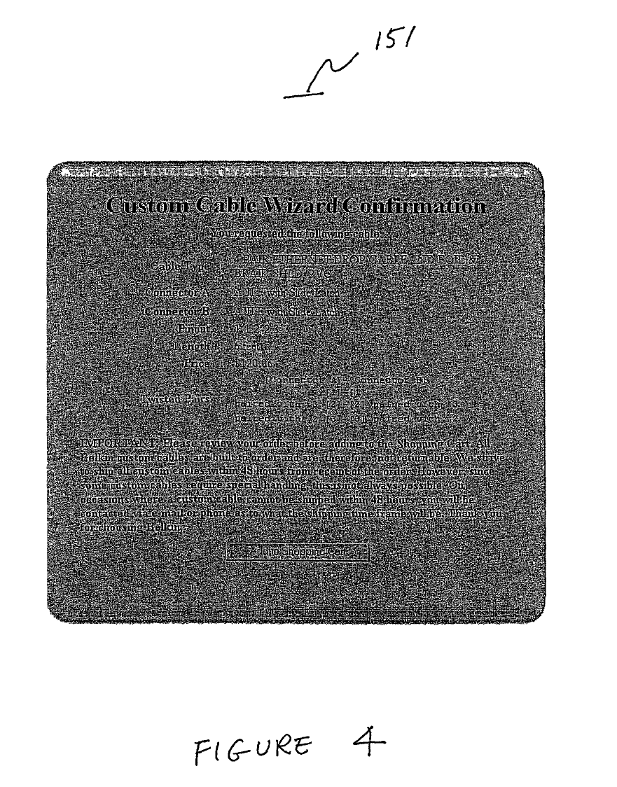

When the consumer is satisfied with pin assignments, the consumer can click on the submit button 165. The consumer is directed to a confirmation screen which summarizes all of the cable attributes and pin assignments just selected. Referring to FIG. 4, there is shown a pin-out summary 151, with connections routed from Connector A to Connector B and separated by a dash (-). Jumpered pins are separated by a equal sign (=).

It is instructive to note the organization of the database of cable types. Referring back to FIG. 1, the database typically resides on a storage device 25 at the web server 21. The database management at the server includes dynamically changing links which can be accessed by any conventional means (e.g., ODBC, SQL) from a database. The database will also have a level of dynamic management which allows a merchant and a consumer to dynamically manage the level of inventory of products and services for the merchant.

The database contains two tables. One table is for a dropdown list of hardware types for the connectors. The second table is a dropdown list of connector and cable types. The latter table has one row for each Connector A that corresponds to a cable type.

In the same row, there are fields associated with connector and cable prices, a list of hardware and a list of connector B types that can match with connector A. It will be understood by one skilled in the art that the relationally linked database may be implemented as a single database comprising all the records of the cable types. The database is implemented with commercial offerings such as Oracle™, SYBASE™, Informix™, DB2™, and Microsoft SQL™

In the exemplary embodiment illustrated, a Microsoft SQL 7.0 database is accessed using ASP script. Active Server Pages is a server side script language especially useful for active database management utilizing a web server. The client-side Java Script applet presents instantaneous results to the consumer. Initially, after the first screen for selecting custom cable characteristics is loaded to the consumer computer, a Java Script array of connectors and corresponding cable and hardware types is stored on 260606.01 14 the storage device 15 at the consumer's computer. In an exemplary embodiment, the array may be set up in the following way (for a BNC female connector):

arrCables[33]=new Array (‘BNCF, 0’, ‘236, 0’, ‘50 OHM Ethernet, PVC’);

arrCables[34] new Array (‘BNCF, 0’, ‘238, 0’, ‘75 OHM, RG59/U COAX, PVC’);

It should be noted that the BNC female connector matches with an Ethernet cable. Therefore, when the consumer chooses a BNC for connector A, the cable type will change to display the characteristics of the Ethernet cable.

Similar arrays control the relationship between the Connector A and the connector B. Likewise, the relationship between the hardware components and the cable components are also arranged in arrays. A sample Java Script for changing one list based on the other list is listed in Appendix A.

As described above, the second screen is for pin assignments. On the second screen, FIG. 3, the data is passed from screen 1 (by HTTP passing) and does not need to access the database. HTTP passing messages are messages to be used in passing around the state of web pages. Since the WWW is not a classical state machine model, this is a typical method of passing around the parameters in a web-based environment. A sample Java Script for dropping pin icons over differing targets on the graphic user interface is listed in Appendix B.

It is contemplated that the above-described embodiment of the present invention may be applicable to a host of different goods or services. For example, consumers with wide choices in selection of clothing, automobiles, food items and various other services or goods may utilize the principles of the present invention to narrow down or further refine their selections. A questionnaire or selection of choices may be framed to the consumer so that the questions appearing are in a simple and directed way that the consumer can understand. The replies help to shape the next page to come in the transmission. The replies may be linked by HTTP protocol to the next entry in the database. Therefore, the merchant may dynamically change the links embedded within the data entries in the database by linking to the appropriate page with a link embedded in the database entry.

The questionnaire or selection of choices may contain many levels of customization. For example, the first questionnaire may be an introductory questionnaire 10 asking the consumer what type of cable he is looking for. The types of cable may include, for example, coaxial or twisted pair cables. They may further include examples such as USB cables and parallel port cables for computers. The first questionnaire may include, for example, visual objects embedded in the web page to show the consumer exactly the type of item the consumer may be looking for. Responses to the first questionnaire may be registered by the consumer in a variety of ways. The responses may be registered via a series of drop down boxes, or as clickable links on the web pages Depending upon responses to the first questionnaire, the consumer may be directed to a second questionnaire which can further refine the choices available for the consumer. Furthermore, a third questionnaire may also depend upon the second questionnaire. It can be seen that each level of questionnaire may depend upon the level of questionnaire preceding the present questionnaire. The level of questionnaire responses may determine the next set of questions to be presented to the consumer. The consumer may then be prompted to enter the choices to express a preference for a certain item rather than another item.

The present invention also contemplates a virtual catalog which is compiled with a web programming language, such as PERL, ASP, Visual Basic, etc. The languages can be compiled on the web server and coded for creating a web page that can be customized to the consumer so that the consumer can be directed to the most recent items for sale in the catalog. The consumer may further be directed to more informational links about the product which the consumer is looking at. In most conventional database interfaces, the links from the interface are typically static. That is, when a mouse glides over a link, the link is static and may not be dynamically dependent on the choices that have been made. The dynamically designated links may aid in keeping the database entries current and updated easily.

The method of the present invention may also be applicable for other choices of goods. The method may be especially useful in categories of goods which have may interlinked options. For instance, take a consumer searching for a pair of shoes on the Internet. The consumer may be interested in a pair of shoes for a particular event. In that case, the questionnaire may be designed so that the consumer is queried as to his preference for formal or casual wear. Once the customer acts on a choice by clicking on a pointer device, the customer is taken to a second questionnaire page where the consumer is queried further. For purposes of further illustrating the example, suppose the consumer chooses a casual style of shoes. The consumer may be presented with a next page including choices such as the style of shoes and whether the choices correspond to a function for the consumer. Recursive levels of customization are required for further specialization. That is, the method of the present invention contemplates a significant number of levels for the consumer to differentiate before the consumer is presented a choice.

The choices while the consumer makes the differentiation choices consist of the myriad of choices that consumers have when it comes to shoes. The consumer may also select a choice of goods which are the equivalent of the goods that are selected for the consumer's favorite choices. The consumer may subsequently mark choices regarding their subsequent consumer choices which are registered in the database as consumer choices are registered on the screen as the selection process occurs. The database choices are registered in the database as a first choice and subsequently chronicled as a second choice for the purposes of marking the consumer's choices are registered in a database and it is stored in a database which is stored within the database as the choices by the consumer are saved in a database of customer choices to be archived.

Although the present invention has been described in various illustrative embodiments, it is not intended to limit the invention to the precise embodiments disclosed herein. Accordingly, this description is to be construed as illustrative only. Those who are skilled in this technology can make carious alterations and modifications without departing from the scope and spirit of this invention. Therefore, the scope of the present invention shall be defined and protected by the following claims and their equivalents. The exclusive use of all modifications within the proper scope of the claims is reserved.

APPENDIX B:

function dropEl () {

if (whichEl ==null) { return; }
if (NS4) { document.releaseEvents(Event.MOUSEMOVE) }
whichEl = null;

var allowFrom;
var toAnother = false;
var toEl = null;
var elSizeX, elSizeY;
var i;
var j;
var maxItem;
var search = 0;
if (currentX >= parseInt (getPos (“elDRAGL_1”))) { search = 1; }
if (currentX >= parseInt (getPos (“elDRAGPairL_1”))) { search = 2; }
if (currentX >= parseInt (getPos (“elBoxL_1”))) { search = 3; }
if (currentX >= parseInt (getPos (“elBoxR_1”))) { search = 4; }
if (currentX >= parseInt (getPos (“elDRAGPairR_1”))) { search = 5; }
if (currentX >= parseInt (getPos (“elDRAGR_1”))) { search = 6; }
toAnother = false;
allowFrom = new Array ();
var dropOnto = “”;
switch (search) {

| | |
|---|---|
| case 1: | //onto PinsLeft |

allowFrom [0] = “elDPAGL”;
allowFrom [1] = “elDRAGR”;
maxItem = PINSLEFT;
elName = “elDRAGL_”;
elSizeX = PINSIZEX;
elSizeY = PINSIZEY;
dropOnto = “Pin”;
break;

case 2: //left pair

allowFrom [0] = “elDRAGPairL”;
maxItem = boxCounter;
elName = “elDPAGPairL_”;
elSizeX = PAIRSIZEX;
elSizeY = PAIRSIZEY;
dropOnto = “Pair”;
break;

case 3: //left box

allowFrom [0] = “elDRAGL”;
allowFrom [1] = “elDRAGR”;
maxItem = boxCounter;
elName = “elBoxL_”;
elSizeX = BOXSIZEX;
elSizeY = BOXSIZEY;
dropOnto = “Box”;
break;

case 4: //right box

allowFrom [0] = “elDRAGL”;
allowFrom [1] = “elDRAGR”;
maxItem = boxCounter;
elName = “elBoxR_”;
elSizeX = BOXSIZEX;
elSizeY = BOXSIZEY;
dropOnto = “Box”;
break;

case 5: //right pair

allowFrom [0] = “elDRAGPairR”;
maxItem = boxCounter;
elName = “elDRAGPairR_”;
elSizeX = PAIRSIZEX;
elSizeY = PAIRSIZEY;
dropOnto = “Pair”;
break;

case 6: //right pin

allowFrom [0] = “elDRAGL”;
allowFrom [1] = “elDRAGR”;
maxItem = PINSRIGHT;
elName = “elDRAGR_”;
elSizeX = PINSIZEX;
elSizeY = PINSIZEY;
dropOnto = “Pin”;
break;

}
allowed = false;
for (k=0; k<allowFrom.length; k++) {

if (getType(activeEl.id) ==allowFrom [k]) {

allowed = true;

}

}
if (allowed) {

for (i=1; i<=maxItem; i++) {

if (activeEl.id == (elName + i)) { continue; } //skip

itself

toEl = document.all [elName + i];
if (toEl.style.visibility == “hidden”) { continue; }
pinLeft = toEl.style.pixelLeft;
pinTop = toEl.style.pixelTop;
if (((currentX >= pinLeft) && (pinLeft + elSizeX >=

currentX)) &&

(currentY >= pinTop) && (pinTop + elSizeY >=

currentY))) {

toAnother = true;
currentX = currentY = 0;
break;

}

}

}
if (toAnother) {

switch (dropOnto) {

case “Pin”:

leftV = rightV = “”;
if (getType(activeEl.id) ==“elDRAGL”) {leftV =

getIdx(activeEl.id); }

if (getType (toEl.id) ==“elDRAGL”) {

if (leftV !=“”) {leftV+=“,”;}
leftV+= getIdx (toEl.id);

}
if (getType (activeEl.id) ==“elDRAGR”) {rightV =

getIdx (activeEl.id);}

if (getType(toEl.id) ==“elDRAGR”) {

if (rightV !=“”) {rightV+=“,”;}

rightV+= getIdx (toEl.id);

}
createBox (leftV, rightV);
break;

case “Box”:

activeEl.style.visibility = “hidden”;
updateBox (activeEl.id, toEl.id);
break;

case “Pair”:

createPair (activeEl.id, toEl.id);
break;

}

} else {

switch (dropOnto) {

case “Pair”:

if

(getType (activeEl.id) .indexOf (“elDRAGPair”) !=−1) {

removePair (activeEl.id);

}
break;

}

}
//drop activeEl back to original position
activeEl.style.pixelLeft = (getPos (activeEl.id)) [0];
activeEl.style.pixelTop = (getPos (activeEl.id)) [1];

}

What is claimed is:

1. A method of representing a search of a database over an interconnected data network between a merchant and a consumer, said consumer equipped with a browser application, said method comprising the steps of:
providing to consumers a set of predetermined choices from said database;
receiving consumer replies to said set of predetermined choices;
dynamically providing a graphic user interface reflecting said consumer replies; and
presenting selected consumer choices as a graphic image on said graphic user interface, wherein said presenting step is accomplished without refreshing said browser application.

2. The method in accordance with claim 1 wherein said interconnected data network is the Internet.

3. The method in accordance with claim 1 wherein said interconnected data network is a virtual private network (“VPN”).

4. The method in accordance with claim 1 wherein said merchant is a vendor of cable connectors.

5. The method in accordance with claim 1 wherein said merchant is a vendor of clothing.

6. The method in accordance with claim 1 wherein said merchant is a vendor of shoes.

7. The method in accordance with claim 1 further comprising the steps of:
updating a database of records wherein each record corresponds to a single good for sale.

8. The method in accordance with claim 1 further comprising the step of:
updating a database of records wherein each record corresponds to a single service for sale.

9. The method in accordance with claim 1 wherein said database is a relational database.

10. The method in accordance with claim 1 wherein said providing step is performed by an Active Server Pages (“ASP”) routine.

11. The method in accordance with claim 1 wherein said dynamically providing step is performed by a Java Script applet.

12. A system for dynamically representing a search of a database over an interconnected data network between a merchant and a consumer, said consumer equipped with a browser application, said system comprising:
means for providing to consumers a set of predetermined choices;
means for receiving consumer replies to said set of predetermined choices;
means for dynamically providing a graphical user interface reflecting said consumer replies without refreshing said browser application; and
means for presenting selected consumer choices as a graphic image on said graphic user interface.

13. The system in accordance with claim 12 wherein said interconnected data network is the Internet.

14. The system in accordance with claim 12 wherein said interconnected data network is a virtual private network (“VPN”).

15. The system in accordance with claim 12 wherein said merchant is a vendor of cable connectors.

16. The system in accordance with claim 12 wherein said merchant is a vendor of clothing.

17. The system in accordance with claim 12 wherein said merchant is a vendor of shoes.

18. The system in accordance with claim 12 further comprising:
means of updating a database of records wherein each record corresponds to a single good for sale.

19. The system in accordance with claim 12 further comprising:
means of updating a database of records wherein each record corresponds to a single service for sale.

20. The system in accordance with claim 12 wherein said database is a relational database.
